(19) United States
(12) Patent Application Publication
(10) Pub. No.: US 2022/0198775 A1
(43) Pub. Date: Jun. 23, 2022

(54) IMAGE PROCESSING METHOD AND APPARATUS, ELECTRONIC DEVICE, STORAGE MEDIUM AND COMPUTER PROGRAM

(71) Applicant: SHANGHAI SENSETIME INTELLIGENT TECHNOLOGY CO., LTD., Shanghai (CN)

(72) Inventors: Jing YUAN, Shanghai (CN); Liang ZHAO, Shanghai (CN)

(21) Appl. No.: 17/693,809

(22) Filed: Mar. 14, 2022

Related U.S. Application Data
(63) Continuation of application No. PCT/CN2020/100728, filed on Jul. 7, 2020.

(30) Foreign Application Priority Data
Sep. 20, 2019 (CN) 201910895227.X

(51) Int. Cl. G06V 10/26; G06V 10/80; G06V 10/77; G06V 10/764; G06V 10/82; G06V 10/774; G06V 10/776; G06V 10/25

(52) U.S. Cl. CPC G06V 10/267; G06V 10/80; G06V 10/7715; G06V 10/764; G06V 2201/03; G06V 10/774; G06V 10/776; G06V 10/25; G06V 10/82

(57) ABSTRACT

Provided are an image processing method and apparatus, and a computer storage medium. The method includes that: first segmentation is performed on a to-be-processed image to determine at least one target image region in the to-be-processed image; second segmentation is performed on the at least one target image region to determine first segmentation results of a target in the at least one target image region; and fusion and segmentation are performed on the first segmentation results and the to-be-processed image to determine a second segmentation result of the target in the to-be-processed image.

### CROSS-REFERENCE TO RELATED APPLICATIONS

This is a continuation of International Patent Application No. PCT/CN2020/100728, filed on Jul. 7, 2020, which claims priority to Chinese Patent Application No. 201910895227.X, filed on Sep. 20, 2019. The disclosures of International Patent Application No. PCT/CN2020/100728 and Chinese Patent Application No. 201910895227.X are hereby incorporated by reference in their entireties.

### BACKGROUND

In the technical field of image processing, segmentation on a Region of Interest (ROI) or a target region is the basis for image analysis and target identification. For example, in medical images, the boundary of one or more organs or tissues is identified clearly by segmentation. The accurate segmentation of the medical image is of great importance to many clinical applications.

### SUMMARY

Embodiments of the application relate to the technical field of computers, and relate, but are not limited to provide an image processing method and apparatus, an electronic device, a computer storage medium and a computer program.

The embodiments of the application provide an image processing method, which includes that: first segmentation is performed on a to-be-processed image to determine at least one target image region in the to-be-processed image; second segmentation is performed on the at least one target image region to determine first segmentation results of a target in the at least one target image region; and fusion and segmentation are performed on the first segmentation results and the to-be-processed image to determine a second segmentation result of the target in the to-be-processed image.

The embodiments of the application further provide an image processing apparatus, which includes: a first segmentation module, configured to perform first segmentation on a to-be-processed image to determine at least one target image region in the to-be-processed image; a second segmentation module, configured to perform second segmentation on the at least one target image region to determine first segmentation results of a target in the at least one target image region; and a fusion and segmentation module, configured to perform fusion and segmentation on the first segmentation results and the to-be-processed image to determine a second segmentation result of the target in the to-be-processed image.

The embodiments of the application further provide an electronic device, which includes: a processor; and a memory, configured to store instructions executable by the processor; and the processor is configured to call the instructions stored in the memory to execute any operation in the image processing method as described above.

The embodiments of the application further provide a computer-readable storage medium, having stored therein a computer program instruction that, when being executed by a processor, causes to implement any operation in the image processing method as described above.

The embodiments of the application further provide a computer program, which includes a computer-readable code; and when the computer-readable code runs in an electronic device, a processor in the electronic device executes any operation in the image processing method as described above.

### BRIEF DESCRIPTION OF THE DRAWINGS

It is to be understood that the above general descriptions and detailed descriptions below are only exemplary and explanatory and not intended to limit the embodiments of the application. According to the following detailed descriptions on the exemplary embodiments with reference to the accompanying drawings, other characteristics and aspects of the embodiments of the application become apparent.

The accompanying drawings, which are incorporated in and constitute a part of this specification, illustrate embodiments consistent with the application and, together with the description, serve to explain the technical solutions in the embodiments of the application.

FIG. 1 is a flowchart of an image processing method provided by an embodiment of the application.

FIG. 2A is a schematic diagram of a sagittal slice of 3D Magnetic Resonance Imaging (MRI) knee joint data provided by an embodiment of the application.

FIG. 2B is a schematic diagram of a coronary slice of 3D MRI knee joint data provided by an embodiment of the application.

FIG. 2C is a schematic diagram of a cartilage shape of a 3D MRI knee joint image provided by an embodiment of the application.

FIG. 3 is a network architecture diagram for implementing an image processing method provided by an embodiment of the application.

FIG. 4 is a schematic diagram of first segmentation provided by an embodiment of the application.

FIG. 5 is a schematic diagram of subsequent segmentation processes after first segmentation provided by an embodiment of the application.

FIG. 6 is a schematic diagram for connecting feature maps provided by an embodiment of the application.

FIG. 7 is another schematic diagram for connecting feature maps provided by an embodiment of the application.

FIG. 8 is a structure diagram of an image processing apparatus provided by an embodiment of the application.

FIG. 9 is a structure diagram of an electronic device provided by an embodiment of the application.

FIG. 10 is another structure diagram of an electronic device provided by an embodiment of the application.

### DETAILED DESCRIPTION

Various exemplary embodiments, features and aspects of the application will be described below in detail with reference to the accompanying drawings. The same reference signs in the drawings represent components with the same or similar functions. Although each aspect of the embodiments is shown in the drawings, the drawings are not required to be drawn to scale, unless otherwise specified.

Herein, special term “exemplary” refers to “use as an example, embodiment or description”. Herein, any “exemplarily” described embodiment cannot be explained to be superior to or better than other embodiments.

In the application, term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B and C may represent including any one or more elements selected from a set formed by A, B and C.

In addition, for better describing the embodiments of the application, many specific details are presented in the following specific implementation modes. It is understood by those skilled in the art that the disclosure may still be implemented even without some specific details. In some examples, methods, means, components and circuits known very well to those skilled in the art are not described in detail, to highlight the subject of the application.

As a degenerative joint disease, arthritis is prone to the hand, hip and knee joint, and is most prone to the knee joint. Thus, there is a need to make clinical analysis and diagnosis on the arthritis. The knee joint region is composed of an articular bone, a cartilage, a meniscus and other important tissues. These tissues are complicated in structure and the contrast of images thereof may be not high. Moreover, as the cartilage of the knee joint has a very complicated tissue structure and an unclear tissue boundary, how to accurately segment the cartilage is a technical problem to be solved urgently.

In related art, a variety of methods are used to evaluate the structure of the knee joint. In the first example, Magnetic Resonance (MR) data of the knee joint is acquired, and a cartilage morphological result (such as the thickness of the cartilage and the surface area of the cartilage) is obtained based on the MR data of the knee joint. The cartilage morphological result is helpful to determine the symptom of knee arthritis and the structural severity. In the second example, the MRI Osteoarthritis Knee Score (MOAKS) is researched with a semi-quantitative scoring method that is evolved based on a geometric relationship between cartilage masks. In the third example, the 3D cartilage label is also a potential standard for extensive quantitative measurement of the knee joint; and the cartilage tag of the knee joint is helpful for computation of the narrowed joint space and the derived distance map, and thus is considered as a reference for evaluation of the structural change of the knee arthritis.

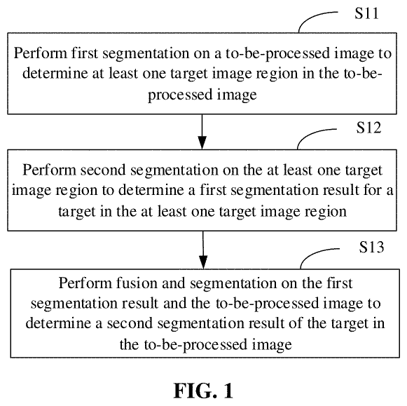

On the basis of the above-described application scenarios, the embodiments of the application provide an image processing method. FIG. 1 is a flowchart of an image processing method provided by an embodiment of the application. As shown in FIG. 1, the image processing method includes the following steps.

In S11, first segmentation is performed on a to-be-processed image to determine at least one target image region in the to-be-processed image.

In S12, second segmentation is performed on the at least one target image region to determine first segmentation results of a target in the at least one target image region.

In S13, fusion and segmentation are performed on the first segmentation results and the to-be-processed image to determine a second segmentation result of the target in the to-be-processed image.

In some embodiments of the application, the image processing method is executed by an image processing apparatus. The image processing apparatus is User Equipment (UE), a mobile device, a user terminal, a terminal, a cell phone, a cordless phone, a Personal Digital Assistant (PDA), a handheld device, a computing device, a vehicle device, a wearable device or the like. The method is be implemented in a manner that the processor calls the computer-readable instructions stored in the memory. Or, the method is executed by a server.

In some embodiments of the application, the to-be-processed image is 3D image data, such as a 3D knee image. The 3D knee images include multiple slice images in a cross-sectional direction of the knee. The target in the to-be-processed images includes the knee cartilage; and the knee cartilage includes at least one of a Femoral Cartilage (FC), a Tibial Cartilage (TC) or a Patellar Cartilage (PC). The to-be-processed images are obtained by scanning the knee region of the tested object (such as the patient) with an image collection device. The image collection device is, for example, a Computed Tomography (CT) device, a MR device, etc. It is to be understood that the to-be-processed images also include an image of another region or another type of image. There are no limits made on the region, type and specific acquisition manner of the to-be-processed image in the application.

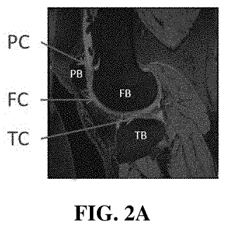

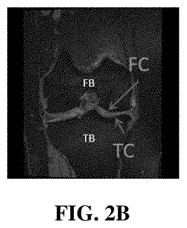

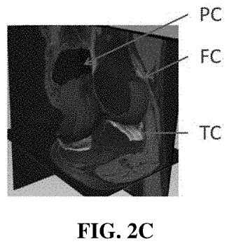

FIG. 2A is a schematic diagram of a sagittal slice of 3D MRI knee joint data provided by an embodiment of the application. FIG. 2b is a schematic diagram of a coronary slice of 3D MRI knee joint data provided by an embodiment of the application. FIG. 2c is a schematic diagram of a cartilage shape of a 3D MRI knee joint image provided by an embodiment of the application. As shown in FIG. 2A, FIG. 2B and FIG. 2C, the knee region includes a Femoral Bone (FB), a Tibial Bone (TB) and a Patellar Bone (PB); and the FC, TC and PC respectively cover the FB, TB and PB, and are connected to the knee joint.

In some embodiments of the application, in order to capture wide-range and thin cartilage structures to further evaluate the knee arthritis, the MRI data are often scanned with a large size (millions of voxels) and a high resolution. For example, each of FIG. 2A, FIG. 2B and FIG. 2C shows 3D MRI knee joint data from an Osteoarthritis Initiative (OAI) database, with the resolution being 0.365 mm*0.365 mm*0.7 mm and the pixel size being 384*384*160. The 3D MRI data having the high pixel resolution in FIG. 2A, FIG. 2B and FIG. 2C display detailed information on shapes, structures and intensities of large organs; and the 3D MRI data having the large pixel size facilitates capture of all critical cartilage and meniscus tissues in the knee joint region, which is convenient for 3D processing and clinical metric analysis.

In some embodiments of the application, the first segmentation is performed on the to-be-processed image to localize the target in the to-be-processed image (such as each cartilage in the knee region). Before the first segmentation is performed on the to-be-processed image, the to-be-processed image is preprocessed. For example, the value ranges for the spacing resolutions and pixel values of the to-be-processed image are unified. With such a manner, the image size is unified to accelerate network convergence and other effects. The specific content and processing manner of the preprocessing are not limited in the application.

In some embodiments of the application, the first segmentation (i.e., coarse segmentation) is performed on the 3D to-be-processed image in step S11, to determine a position of an ROI defined by a 3D bounding box in the to-be-processed image, thereby intercepting at least one target image region from the to-be-processed image according to the 3D bounding box. In response to a case where multiple target image regions are intercepted from the to-be-processed image, the target image regions correspond to different types of targets. For example, in a case where the target is the knee cartilage, the target image regions respectively correspond to FC, TC and PC image regions. The specific type of the target is not limited in the application.

In some embodiments of the application, the first segmentation is performed on the to-be-processed image through a first segmentation network. The first segmentation network use, for example, a VNet encoding-decoding structure (i.e., multistage down-sampling+multistage up-sampling), or use a Fast Region-based Convolutional Neural Network (Fast RCNN) or the like, so as to detect the 3D bounding box. There are no limits made on the structure of the first segmentation network in the application.

In some embodiments of the application, after the at least one target image region in the to-be-processed image is obtained, the second segmentation (i.e., fine segmentation) is performed on the at least one target image region to obtain the first segmentation result of the target in the at least one target image region in step S12. Each target image region is segmented through a second segmentation network corresponding to each target to obtain the first segmentation result of each target image region. For example, in a case where the target is the knee cartilage (including the FC, the TC and the PC), three second segmentation networks respectively corresponding to the FC, the TC and the PC are provided. Each second segmentation network use, for example, the VNet encoding-decoding structure. There are no limits made on the specific structure of each second segmentation network in the application.

In some embodiments of the application, in a case where multiple first segmentation results are determined, a first segmentation result of each target image region is fused to obtain a fusion result in step S13; and then, the third segmentation is performed on the fusion result according to the to-be-processed image to obtain the second segmentation result of the target in the to-be-processed image. In this way, further segmentation is performed on the overall result of fusion of multiple targets, and thus the accuracy of segmentation will be improved.

According to the image processing method in the embodiment of the application, to-be-processed images are segmented to determine the target image regions in the image, the target image regions are segmented again to determine the first segmentation results of the target, and the first segmentation results are fused and segmented to determine the second segmentation result of the to-be-processed image. Therefore, with multiple times of segmentation, the accuracy of the segmentation result of the target in the to-be-processed image is improved.

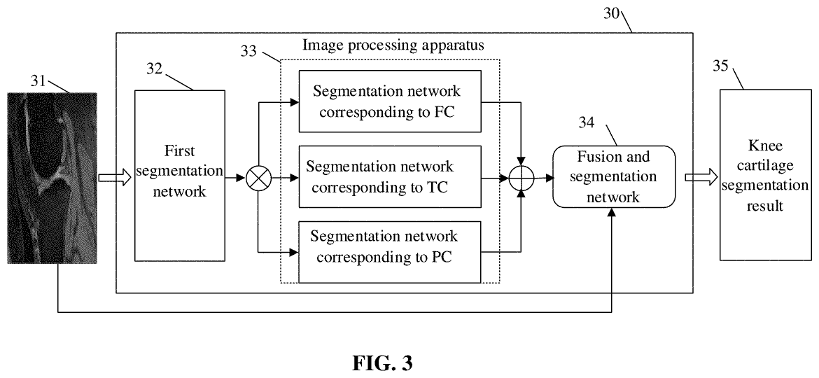

FIG. 3 is a network architecture diagram for implementing an image processing method provided by an embodiment of the application. As shown in FIG. 3, the application scenario of the application will be described for example by taking the to-be-processed image as a 3D knee image 31 With the 3D knee image 31 as the above to-be-processed image, the 3D knee image 31 is input to the image processing apparatus 30; and the image processing apparatus 30 processes the 3D knee image 31 according to the image processing method described in the above embodiments to generate and output a knee cartilage segmentation result 35.

In some embodiments of the application, the 3D knee image 31 is input to the first segmentation network 32 for coarse cartilage segmentation to obtain a 3D bounding box for an ROI of each knee cartilage; and an image region of each knee cartilage (image region including the FC, the TC and the PC) is intercepted from the 3D knee image 31.

In some embodiments of the application, the image regions of each knee cartilage are respectively input to the corresponding second segmentation network 33 for fine cartilage segmentation to obtain a fine segmentation result of each knee cartilage, i.e., an accurate position of each knee cartilage. Then, the fine segmentation result of each knee cartilage is fused, and the fusion result and the knee image are input to a fusion segmentation network 34 for processing to obtain a final knee cartilage segmentation result 35. Herein, the fusion segmentation network 34 is configured to perform third segmentation on the fusion result according to the 3D knee image. In this way, further segmentation is performed on the fusion result of the segmentation results of the FC, the TC and the PC based on the knee image, and thus the knee cartilage will be accurately segmented.

In some embodiments of the application, the coarse segmentation is performed on the to-be-processed image in step S11. Step S11 includes the following operations.

Feature extraction is performed on the to-be-processed image to obtain a feature map of the to-be-processed image.

The feature map is segmented to determine a bounding box of the target in the feature map.

The at least one target image region is determined from the to-be-processed image according to the bounding box of the target in the feature map.

For example, the to-be-processed image is high-resolution 3D image data. Features of the to-be-processed image are extracted through a convolutional layer or a down-sampling layer of the first segmentation network, so as to reduce the resolution ratio of the to-be-processed image and reduce the amount of processing data. Then, the obtained feature image is segmented through a first segmentation sub-network of the first segmentation network to obtain bounding boxes of multiple targets in the feature map. The first segmentation sub-network includes multiple down-sampling layers and multiple up-sampling layers (or multiple convolutional layers and deconvolutional layers), multiple residual layers, an activation layer, a normalization layer, etc. There are no limits made on the specific type of the first segmentation sub-network in the application.

In some embodiments of the application, the image regions of each target in the to-be-processed image are segmented from the original to-be-processed image according to the bounding box of each target to obtain at least one target image region.

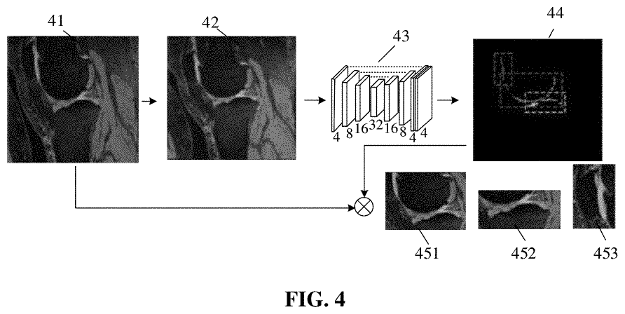

FIG. 4 is a schematic diagram of first segmentation provided by an embodiment of the application. As shown in FIG. 4, the feature extraction is performed on the high-resolution to-be-processed image 41 through the convolutional layer or down-sampling layer (not shown) of the first segmentation network to obtain the feature map 42. For example, the to-be-processed image 41 has the resolution of 0.365 mm×0.365 mm×0.7 mm and the pixel size of 384×384×160; and after being processed, the feature map 42 has the resolution of 0.73 mm×0.7 3 mm×0.7 mm and the pixel size of 192×192×160. In this way, the amount of processing data will be reduced.

In some embodiments of the application, the feature map is segmented through the first segmentation sub-network 43. The first segmentation sub-network 43 is of the encoding-decoding structure. The encoding portion includes three residual blocks and a down-sampling layer, so as to obtain different scales of feature maps, for example, the number of channels corresponding to each obtained feature map is 8, 16 and 32. The decoding portion includes three residual blocks and an up-sampling layer, so as to restore the scale of the feature map to the original input size, for example, to the feature map of which the number of channels is 4. A residual block includes multiple convolutional layers, a fully connected layer, and the like. The convolutional layer in the residual block has the filter size of 3, step size of 1 and zero-padding of 1. The down-sampling layer includes a convolutional layer having the filter size of 2 and the step size of 2, and the up-sampling layer includes a deconvolutional layer having the filter size of 2 and the step size of 2. There are no limits made on the structure of the residual block as well as the number and filter parameters of the up-sampling layers and down-sampling layers in the application.

In some embodiments of the application, the feature map 42 of which the number of channels is 4 is input to a first residual block of the encoding portion, and the output residual result is input to the down-sampling layer to obtain a feature map of which the number of channels is 8; and then, the feature map of which the number of channels is 8 is input to a next residual block, and the output residual result is input to a next down-sampling layer to obtain a feature map of which the number of channels is 16; and so on, to obtain a feature map of which the number of channels is 32. Then, the feature map of which the number of channels is 32 is input to a first residual block of the decoding portion, and the output residual result is input to the up-sampling layer to obtain the feature map of which the number of channels is 16; and so on, to obtain the feature map of which the number of channels is 4.

In some embodiments of the application, activation and batch normalization is performed on the feature map of which the number of channels is 4 by an activation layer (PReLU) and a batch normalization layer of the first segmentation sub-network 43, and the normalized feature map 44 is output. Bounding boxes of multiple targets in the feature map 44 are determined, which refers to three dash boxes in FIG. 4. The region defined by these bounding boxes is the ROI of the target.

In some embodiments of the application, the to-be-processed image 41 is intercepted according to bounding boxes of multiple targets to obtain the target image regions defined by the bounding boxes (referring to the FC image region 451, the TC image region 452 and the PC image region 453 in FIG. 4). The resolution of each target image region is the same as that of the to-be-processed image 41 to avoid loss of information in the image.

Thus, with the image segmentation manner shown in FIG. 4, the target image regions are determined in the to-be-processed image to implement the coarse segmentation of the to-be-processed image.

In some embodiments of the application, the fine segmentation is performed on each target image region of the to-be-processed image in step S12. Step S12 includes the following operations:

Performing feature extraction on the at least one target image region to obtain a first feature map of the at least one target image region;

Performing N stages down-sampling on the first feature map to obtain an N-stage second feature map, wherein the N is an integer greater than or equal to 1;

Performing N stages up-sampling on a N-th stage second feature map to obtain an N-stage third feature map; and

Classifying the N-th stage third feature map to obtain the first segmentation results of the target in the at least one target image region.

For example, in a case that there are multiple target image regions, the fine segmentation is performed on each target image region by each respective second segmentation network according to a target type corresponding to each target image region. For example, in a case where the target is the knee cartilage, three second segmentation networks respectively corresponding to the FC, the TC and the PC are provided.

In this way, for any target image region, features of the target image region are extracted through a convolutional layer or a down-sampling layer of a corresponding second segmentation network, so as to reduce the resolution ratio of the target image region and reduce the amount of processing data. After processing, a first feature map of the target image region, such as the feature map of which the number of channels is 4, is obtained.

In some embodiments of the application, N stages down-sampling are performed on the first feature image through N down-sampling layers (where N is an integer greater than or equal to 1) of the corresponding second segmentation network to sequentially reduce a scale of the feature map, and then to obtain each stage second feature image, such as a three-stage second feature map of which the number of channels is 8, 16 and 32. N stages up-sampling are performed on the N-th stage second feature map through N up-sampling layers to sequentially restore the scale of the feature map, and then to obtain each stage of third feature map, such as a three-stage second feature map of which the number of channels is 16, 8 and 4.

In some embodiments of the application, the N-th stage third feature map is activated by a sigmoid layer of the second segmentation network to shrink the N-th stage third feature map to a single channel, thereby implementing classification on the position belonging to the target (for example, referred to as a foreground region) and the position not belonging to the target (for example, referred to as a background region) in the N-th stage third feature map. For example, the value of the feature point in the foreground region is close to 1, and the value of the feature point in the background region is close to 0. In this way, the first segmentation result of the target in the target image region will be obtained.

With such a manner, target image regions are processed respectively, and the first segmentation result of each of the target image regions will be obtained, thereby implementing the fine segmentation on each target image region.

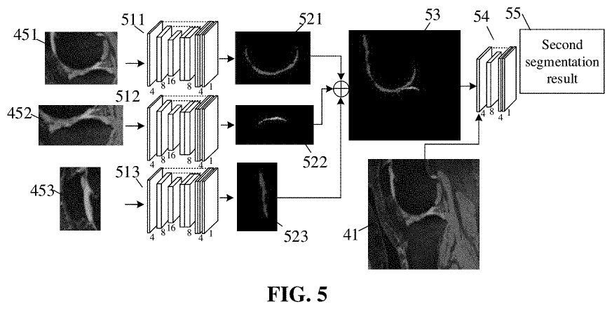

FIG. 5 is a schematic diagram of subsequent segmentation processes after first segmentation provided by an embodiment of the application. As shown in FIG. 5, the second segmentation network 511 for the FC, the second segmentation network 512 for the TC and the second segmentation network 513 for the PC are provided. The feature extraction is respectively performed on each high-resolution target image region (i.e., the FC image region 451, the TC image region 452 and the PC image region 453 in FIG. 5) by a convolutional layer or a down-sampling layer (not shown) of each second segmentation network to obtain each first feature map, i.e., the first feature maps for the FC, the TC and the PC. Then, each first feature map is respectively input to the encoding-decoding structure of the corresponding second segmentation network for segmentation.

In the embodiment of the application, the encoding portion of each second segmentation network includes two residual blocks and a down-sampling layer, so as to obtain different scales of feature maps, for example, the number of channels corresponding to each obtained feature map is 8 and 16. The decoding portion of each second segmentation network includes two residual blocks and an up-sampling layer, so as to restore the scale of the feature map to the original input size, for example, to the third feature map of which the number of channels is 4. A residual block includes multiple convolutional layers, a fully connected layer and the like. The convolutional layer in the residual block has the filter size of 3, step size of 1 and zero-padding of 1. The down-sampling layer includes a convolutional layer having the filter size of 2 and the step size of 2, and the up-sampling layer includes a deconvolutional layer having the filter size of 2 and the step size of 2. In this way, the receptive field of the nerve cell will be balanced, and the memory consumption of the Graphics Processing Unit (GPU) will be reduced. For example, the image processing method in the embodiment of the application is implemented based on the GPU with limited (such as 12 GB) memory resource.

It is to be understood that the encoding-decoding structure of the second segmentation network is set by a person skilled in the art according to actual situations. There are no limits made on the structure of the residual block as well as the number and filter parameters of the up-sampling layers and down-sampling layers in the second segmentation network in the application.

In some embodiments of the application, the first feature map of which the number of channels is 4 is input to a first residual block of the encoding portion, and the output residual result is input to the down-sampling layer to obtain a first stage of second feature map of which the number of channels is 8; and the feature map of which the number of channels is 8 is input to a next residual block, and the output residual result is input to a next down-sampling layer to obtain a second stage of second feature map of which the number of channels is 16. Then, the second stage of second feature map of which the number of channels is 16 is input to a first residual block of the decoding portion, and the output residual result is input to the up-sampling layer to obtain a first stage of third feature map of which the number of channels is 8; and then, the feature map of which the number of channels is 8 is input to a next residual block, and the output residual result is input to a next up-sampling layer to obtain a second stage of third feature map of which the number of channels is 4.

In some embodiments of the application, the second stage of third feature map of which the number of channels is 4 is shrunk to a single channel by a sigmoid layer of each second segmentation network to obtain the first segmentation result of the target in each target image region, i.e., the FC segmentation result 521, the TC segmentation result 522 and the PC segmentation result 523 in FIG. 5.

In some embodiments of the application, the step that the N stages up-sampling are performed on the N-th stage second feature map to obtain the N-stage third feature map includes the following operations:

Connecting a third feature map obtained from an i-th stage up-sampling to an (N−i)-th stage second feature map, based on an attention mechanism in a case where i sequentially takes a value from 1 to N, to obtain an i-th stage third feature map, wherein N denotes a number of stages of down-sampling and up-sampling, and i is an integer. For example, in order to improve the segmentation effect, the skip connection between feature maps is extended by using the attention mechanism to better implement information transfer between the feature maps. The third feature map obtained from the i-th stage up-sampling (1≤i≤N) is connected to the corresponding (N−i)-th stage second feature map, and the connection result serves as the i-th stage third feature map; and in case of i=N, the feature map obtained from the N-th stage up-sampling is connected to the first feature map. There are no limits made on the value of the N in the application.

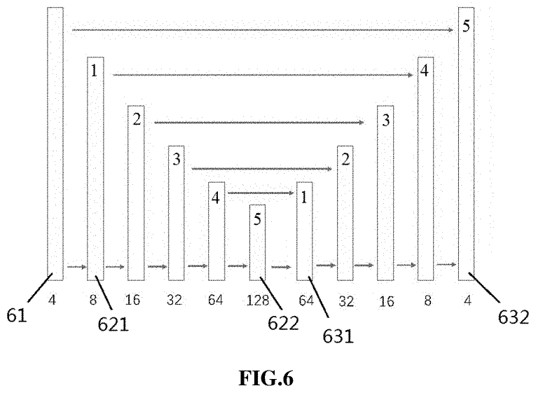

FIG. 6 is a schematic diagram for connecting feature maps provided by an embodiment of the application. As shown in FIG. 6, in a case where the number of stages for the down-sampling and up-sampling is 5 (N=5), the down-sampling is performed on the first feature map 61 (the number of channels is 4) to obtain the first stage of second feature map 621 (the number of channels is 8); and after stages of down-sampling, the fifth stage of second feature map 622 (the number of channels is 128) is obtained.

In some embodiments of the application, five stages up-sampling are performed on the second feature map 622 to obtain respective third feature maps. When the number of stages for up-sampling is i=1, the third feature map obtained from the first stage of up-sampling is connected to the fourth stage of second feature map (the number of channels is 64) to obtain the first stage of third feature map 631 (the number of channels is 64). Similarly, when i=2, the third feature map obtained from the second stage of up-sampling is connected to the third stage of second feature map (the number of channels is 32); when i=3, the third feature map obtained from the third stage of up-sampling is connected to the second stage of second feature map (the number of channels is 16); when i=4, the third feature map obtained from the fourth stage of up-sampling is connected to the first stage of second feature map (the number of channels is 8); and when i=5, the third feature map obtained from the fifth stage of up-sampling is connected to the first feature map (the number of channels is 4) to obtain the fifth stage of third feature map 632.

As shown in FIG. 5, in a case where the number of stages for down-sampling and up-sampling is N=2, the third feature map (the number of channels is 8) obtained from the first stage of up-sampling is connected to the first stage of second feature map of which the number of channels is 8; and the third feature map (the number of channels is 4) obtained from the second stage of up-sampling is connected to the first feature map of which the number of channels is 4.

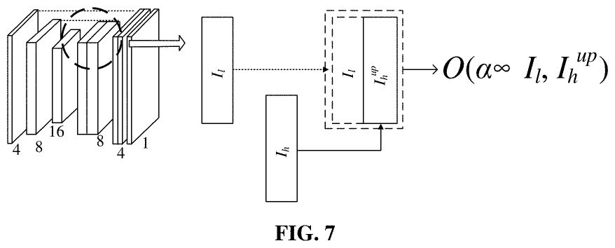

FIG. 7 is another schematic diagram for connecting feature maps provided by an embodiment of the application. As shown in FIG. 7, for any second segmentation network, the second stage of second feature map (the number of channels is 16) of the second segmentation network is represented as Iₕ, the third feature map (the number of channels is 8) obtained by performing the first stage of up-sampling on the second feature map is represented as Iₕ^{up}, and the first stage of second feature map (the number of channels is 8) is represented as Iₗ. The third feature map Iₕ^{up} obtained from the first stage of up-sampling is connected to the first stage of second feature map Iₗ through o(α ⊙Iₗ, Iₕ^{up}) based on the attention mechanism (corresponding to the dashed circle portion in FIG. 7), to obtain the first stage of third feature map after connection. o represents the connection along the channel dimension, α represents the attention weight of the first stage of second feature map Iₗ, and ⊙ represents element-by-element multiplication. α is represented by formula (1):

$$α = m ( {σ}_{r} ( {c}_{l} ( {I}_{l} ) + {c}_{h} ( {I}_{h}^{u p} ) ) ) \qquad ( 1 )$$

In the formula (1), Cₗ and Cₕ respectively represent convolution on the Iₗ and the Iₕ^{up}, for example, the filter size during convolution is 1 and the step size is 1; σᵣ represents activation on the convolved summation result, for example, the activation function is a ReLU activation function; and m represents convolution on the activation result, for example, the filter size during convolution is 1 and the step size is 1.

In this way, in the embodiment of the application, the information transfer between the feature maps is better implemented by using the attention mechanism, which improves the segmentation effect of the target image region, and fine details will be captured by using a multi-resolution context.

In some embodiments of the application, step S13 includes that: each of the first segmentation result is fused to obtain a fusion result; and third segmentation is performed on the fusion result according to the to-be-processed image to obtain the second segmentation result of the to-be-processed image.

For example, after the first segmentation result of the target in each target image region is obtained, the fusion is performed on each of the first segmentation result to obtain the fusion result; and then, the fusion result and the original to-be-processed image are input to a fusion segmentation network for further segmentation, thereby perfecting the segmentation effect for the whole image.

As shown in FIG. 5, the FC segmentation result 521, the TC segmentation result 522 and the PC segmentation result 523 are fused to obtain a fusion result 53. In the fusion result 53, the background channel is excluded and only three cartilage channels are retained.

As shown in FIG. 5, a fusion segmentation network 54 is designed. The fusion segmentation network 54 is a neutral network of the encoding-decoding structure. The fusion result 53 (including the three cartilage channels) and the original to-be-processed image 41 (including one channel) are used as four-channel image data and input to the fusion segmentation network 54 for processing.

In some embodiments of the application, the encoding portion of the fusion segmentation network 54 includes one residual block and the down-sampling layer, and the decoding portion thereof includes one residual block and the up-sampling layer. Each residual block includes multiple convolutional layers, a fully connected layer and the like. The convolutional layer in the residual block has the filter size of 3, step size of 1 and zero-padding of 1. The down-sampling layer includes a convolutional layer having the filter size of 2 and the step size of 2, and the up-sampling layer includes a deconvolutional layer having the filter size of 2 and the step size of 2. There are no limits made on the structure of the residual block, the filter parameter of the up-sampling layer and the down-sampling layer, and the number of residual blocks, up-sampling layers and down-sampling layers in the application.

In some embodiments of the application, the four-channel image data is input to a residual block of the encoding portion, and the output residual result is input to the down-sampling layer to obtain a feature map of which the number of channels is 8; the feature map of which the number of channels is 8 is input to a residual block of the decoding portion, and the output residual result is input to the up-sampling layer to obtain a feature map of which the number of channels is 4. The feature map of which the number of channels is 4 is activated to obtain a single-channel feature map as a final second segmentation result 55.

In this way, the segmentation effect will be further improved from the whole cartilage structure.

In some embodiments of the application, the image processing method in the embodiment of the application is implemented through the neutral network. The neutral network at least includes a first segmentation network, at least one second segmentation network and a fusion segmentation network. Before use of the neutral network, the neutral network is trained.

The method for training the neutral network includes that: the neutral network is trained according to a preset training set, where the training set includes multiple sample images and an annotation segmentation result of each sample image.

For example, the training set is preset to train the neutral network according to the embodiment of the application. The training set includes multiple sample images (i.e., 3D knee images); and the position of each knee cartilage (i.e., the FC, the TC and the PC) in the sample images is annotated to serve as an annotation segmentation result of each sample image.

During training, the sample images are input into the neutral network for processing, and second segmentation results of the sample images are output; a network loss of the neutral network is determined according to the second segmentation results and the annotation segmentation results of the sample images; and network parameters of the neutral network are adjusted according to the network loss. After multiple times of adjustment, the trained neutral network is obtained in a case where a preset condition (such as network convergence) is met.

It can be seen that the neutral network for image segmentation is trained according to the sample images and the annotation segmentation results of the sample images in the embodiment of the application.

In some embodiments of the application, the step that the neutral network is trained according to the preset training set includes the following operations.

A sample image is input into the first segmentation network, and each sample image region of each target in the sample image is output.

Each sample image region is respectively input into the second segmentation network corresponding to each target, and first segmentation results of the target in the respective sample image region are output.

The first segmentation results of the target in each sample image region and the sample image are input into the fusion segmentation network, and a second segmentation result of the target in each sample image is output.

A network loss of the first segmentation network, the second segmentation network and the fusion segmentation network is determined according to the second segmentation results and the annotation segmentation results of the multiple sample images.

Network parameters of the neutral network are adjusted according to the network loss.

For example, a sample image is input to the first segmentation network for coarse segmentation to obtain sample image regions of targets in the sample images, i.e., image regions of the FC, TC and PC; each sample image region is respectively input to the second segmentation network corresponding to each target for fine segmentation to obtain the first segmentation results of the targets in the sample image regions; and the first segmentation results are fused, and the obtained fusion results and the sample images are simultaneously input to the fusion segmentation network, which further improves the segmentation effect from the whole cartilage structure to obtain the second segmentation results of the targets in the sample images.

In some embodiments of the application, multiple sample images are respectively input to the neutral network for processing to obtain second segmentation results of the multiple sample images. A network loss of each of the first segmentation network, the second segmentation network and the fusion segmentation network is determined according to the second segmentation results and the annotation segmentation results of the multiple sample images. The total loss of the neutral network is represented as a formula (2):

$${\sum }_{j} [ ( {\sum }_{c = \{ f , t , p \}}^{ } {L}_{s} ( {x}_{j , c} , {y}_{j , c} ) ) + {L}_{m}^{1} + {L}_{m}^{2} ] \qquad ( 2 )$$

In the formula (2), xⱼ represents the jth sample image, yⱼ represents the jth sample image label, x_{j,c} represents the image region of the jth sample image, y_{j,c} represents the region label of the jth sample image, c respectively is one of f, t and p, the f, t and p respectively represent the FC, the TC and the PC, Lₘ¹ represents the network loss of the first segmentation network, Lₛ (x_{j,c},y_{j,c}) represents the network loss of each second segmentation network, and Lₘ² represents the network loss of the fusion segmentation network. The loss of each network is set according to an actual application scenario. In an example, the network loss of each network is a multi-stage cross-entropy loss function. In another example, when the neutral network is trained, an identifier is further provided; the identifier is configured to identify the second segmentation result of the target in the sample image; the identifier and the fusion segmentation network form an adversarial network. Correspondingly, the network loss of the fusion segmentation network includes an adversarial loss, and the adversarial loss is obtained according to an identification result of the identifier on the second segmentation result. In the embodiment of the application, the loss of the neutral network is obtained based on the adversarial loss, and the training error (embodied by the adversarial loss) from the adversarial network is backwardly propagated to the second segmentation network corresponding to each target so as to enable joint learning of shape and spatial constraint. Therefore, the neutral network is trained according to the loss of the neutral network, and the trained neutral network accurately implements segmentation on different cartilage images based on shape and spatial relations among different cartilages.

It is to be noted that the above described content is only for illustrative description of the loss function for each stage of neutral network and is not limited in the application.

In some embodiments of the application, after the total loss of the neutral network is obtained, the network parameters of the neutral network are adjusted according to the network loss. After multiple times of adjustment, the trained neutral network will be obtained in a case where a preset condition (such as network convergence) is met.

In this way, the training process for the first segmentation network, the second segmentation network and the fusion segmentation network is implemented to obtain the high-precision neutral network.

In some embodiments of the application, Table 1 illustrates indicators corresponding to five different methods for segmenting corresponding knee cartilages. The P2 represents the method for image processing by using the trained neutral network and using the network frameworks shown in FIG. 3 to FIG. 7 when the neutral network is trained based on the adversarial network. The P1 represents the method for image processing by using the trained neutral network and using the network framework shown in FIG. 3 to FIG. 7 when the adversarial network is not used to train the neutral network. The D1 represents the method for processing the image by using a Dense ASPP network structure to replace the residual block and the network structure of skip connection base on the attention mechanism on the basis of the corresponding method of P2. The D2 represents the method for image processing by using the Dense ASPP network structure to replace a deepest network structure in the network structure of skip connection based on the attention mechanism shown in FIG. 6 on the basis of the corresponding method of P2, where the deepest network structure represents a network structure on which the third feature map obtained from the first stage up-sampling will be connected to the fourth stage of second feature map (the number of channels is 64). The CO represents the method for image segmentation by the first segmentation sub-network 43 shown in FIG. 4, and the segmentation result obtained by CO is a coarse segmentation result.

Table 1 shows indicators for evaluating FC, TC and PC segmentation. All indicators for evaluating cartilage segmentation are further shown in Table 1. The segmentation on all cartilages is a segmentation method through which the FC, TC and PC are segmented as a whole and distinguished from the background portion.

In Table 1, three indicators for evaluating the image segmentation are used to compare effects of several image processing methods. Three indicators for evaluating the image segmentation are a Dice Similarity Coefficient (DSC), a Volumetric Overlap Error (VOE) and an Average Surface Distance (ASD) respectively. The DSC indicator reflects a similarity between an image segmentation labeling result (real segmentation result) and the image segmentation result that is obtained by using the neutral network. Both the VOE and the ASD reflect a difference between the image segmentation result obtained by the neutral network and the image segmentation labeling result. The higher DSC indicates that the image segmentation result obtained by using the neutral network is closer to an actual situation; and the lower VOE or ASD indicates that the difference between the image segmentation result obtained by the neutral network and the real situation is smaller.

In Table 1, table cells where values of the indicators are located are divided into two rows, the first row representing average values for indicators of multiple sampling points, and the second row representing standard deviations for indicators of multiple sampling points. For example, when the method of D1 is used for segmentation, indicators of the DSC for the FC are divided into two rows, and respectively are 0.862 and 0.024, where 0.862 is the average value and 0.024 is the standard deviation.

As can be seen from Table 1, as for P2, when comparing with P1, D1, D2 and C0, the DCS of P2 is the highest, and the VOE and the ASD are the lowest. Thus, compared with P1, D1, D2 and C0, the imaging segmentation result obtained by using the P2 is more suitable for the actual situation.

TABLE 1
Comparison between evaluating indicators for segmenting
knee cartilages by using different methods

| | | | | | | | | | | All cartilages | | |
|---|---|---|---|---|---|---|---|---|---|---|---|---|
| | FC | | | TC | | | PC | | | Segmentation result | | |
| | DSC | VOE | ASD | DSC | VOE | ASD | DSC | VOE | ASD | DSC | VOE | ASD |
| D1 | 0.862 | 24.15 | 0.103 | 0.869 | 22.93 | 0.104 | 0.844 | 26.65 | 0.107 | 0.866 | 23.59 | 0.095 |
| | 0.024 | 3.621 | 0.042 | 0.034 | 5.184 | 0.061 | 0.052 | 7.429 | 0.049 | 0.023 | 3.475 | 0.026 |
| D2 | 0.832 | 28.64 | 0.131 | 0.879 | 21.38 | 0.088 | 0.861 | 23.69 | 0.091 | 0.851 | 25.94 | 0.111 |
| | 0.025 | 3.618 | 0.059 | 0.038 | 5.972 | 0.055 | 0.040 | 6.027 | 0.051 | 0.023 | 3.393 | 0.036 |
| C0 | 0.814 | 31.30 | 0.205 | 0.806 | 32.42 | 0.199 | 0.771 | 35.74 | 0.350 | 0.809 | 31.99 | 0.213 |
| | 0.029 | 4.155 | 0.095 | 0.033 | 4.577 | 0.055 | 0.132 | 14.56 | 0.129 | 0.031 | 4.350 | 0.095 |
| P1 | 0.868 | 23.19 | 0.108 | 0.854 | 25.17 | 0.126 | 0.824 | 28.78 | 0.201 | 0.862 | 24.24 | 0.110 |
| | 0.023 | 3.514 | 0.067 | 0.029 | 4.173 | 0.059 | 0.104 | 12.45 | 0.439 | 0.023 | 3.457 | 0.048 |
| P2 | 0.900 | 18.82 | 0.074 | 0.889 | 19.81 | 0.082 | 0.880 | 21.19 | 0.075 | 0.893 | 19.19 | 0.073 |
| | 0.037 | 6.006 | 0.041 | 0.038 | 6.072 | 0.051 | 0.043 | 6.594 | 0.038 | 0.034 | 5.434 | 0.034 |

According to the image processing method in the embodiment of the application, the ROI of the target (such as the knee cartilage) in the to-be-processed image is determined by coarse segmentation; and the cartilages in respective ROIs are accurately labeled by using multiple parallel segmentation agents. The three cartilages are fused by a fusion layer and end-to-end segmentation is performed by fusion learning. In this way, complex subsequent processing steps are avoided, ensuring that the fine segmentation is performed on the original high-resolution ROI, and the sample unbalanced problem is alleviated, thereby implementing accurate segmentation on multiple targets in the to-be-processed image.

In related art, during diagnosis of the knee arthritis, the radiologist needs to check 3D medical images one by one to detect clues of joint degeneration and manually measure corresponding quantitative parameters. However, it is difficult to visually determine the symptom of the knee arthritis because the radiographs of different individuals may change a lot. Hence, in the research of the knee arthritis, it is proposed an automatic implementation method for segmentation of the knee cartilage and meniscus in the related art. In a first example, the joint target function is learnt from a multi-plane two-dimensional Deep Convolution Neural Network (DCNN), and thus a TC classifier is proposed. Nevertheless, the 2.5-dimensional feature learning strategy used to propose the TC classifier may be not sufficient to represent comprehensive information of the organ/tissue segmentation in a 3D space. In a second example, spatial priori knowledge generated by using multi-modal image registration on skeletons and cartilages is used to establish a joint policy for cartilage classification. In a third example, a two-dimensional Fully Convolutional Network (FCN) is also used to train a tissue probability predictor to drive cartilage reconstruction based on 3D deformable single-sided grids. Although these methods have good accuracy, the results thereof are relatively sensitive to settings of shape and spatial parameters.

According to the image processing method in the embodiment of the application, the fusion layer does not only fuse the cartilages from multiple agents, but also reversely propagate the training loss from the fusion network to each agent. The multi-agent learning framework obtains the fine-grained segmentation from ROIs and ensures the spatial constraints between different cartilages, thereby implementing joint learning of the shape and spatial constraints, i.e., being not sensitive to the settings of the shape and spatial parameters. The method meets limitations on GPU resources, and smoothly trains the challenging data. In addition, the method optimizes the skip connection by using the attention mechanism, which enables to better capture the fine details by using the multi-resolution context function, thereby improving the accuracy.

The imaging processing method in the embodiment of the application is applied to the diagnosis, evaluation, surgery planning system and other application scenarios of the knee arthritis based on artificial intelligence. For example, the doctor will effectively obtain the accurate cartilage segmentation with the method to analyze the knee disease; the researcher will process a large amount of data with the method to analyze the bone arthritis in a large scale; and the method is beneficial to surgery planning of the knee. There are no limits made on the specific scenarios in the application.

It can be understood that the method embodiments mentioned in the application are combined with each other to form a combined embodiment without departing from the principle and logic, which is not elaborated in the embodiments of the application for the sake of simplicity. It can be understood by those skilled in the art that in the method of the specific implementation modes, the specific execution sequence of each step is determined in terms of the function and possible internal logic.

In addition, the application further provides an image processing apparatus, an electronic device, a computer readable storage medium and a program, all of which are configured to implement any image processing method provided by the application. The corresponding technical solutions and descriptions refer to the corresponding descriptions in the method and will not be elaborated herein.

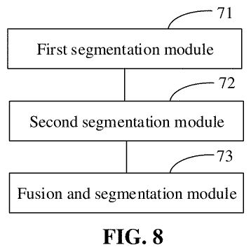

FIG. 8 is a structure diagram of an image processing apparatus provided by an embodiment of the application. As shown in FIG. 8, the imaging processing apparatus includes: a first segmentation module 71, a second segmentation module 72 and a fusion and segmentation module 73.

The first segmentation module 71 is configured to perform first segmentation on a to-be-processed image to determine at least one target image region in the to-be-processed image. The second segmentation module 72 is configured to perform second segmentation on the at least one target image region to determine first segmentation results of a target in the at least one target image region. The fusion and segmentation module 73 is configured to perform fusion and segmentation on the first segmentation results and the to-be-processed image to determine a second segmentation result of the target in the to-be-processed image.

In some embodiments of the application, the fusion and segmentation module includes: a fusion submodule, configured to fuse each first segmentation result to obtain a fusion result; and a segmentation submodule, configured to perform third segmentation on the fusion result according to the to-be-processed image to obtain the second segmentation result of the to-be-processed image.

In some embodiments of the application, the first segmentation module includes: a first extraction submodule, configured to perform feature extraction on the to-be-processed image to obtain a feature map of the to-be-processed image; a first segmentation submodule, configured to segment the feature map to determine a bounding box of the target in the feature map; and a determination submodule, configured to determine the at least one target image region from the to-be-processed image according to the bounding box of the target in the feature map.

In some embodiments of the application, the second segmentation module includes: a second extraction submodule, configured to perform feature extraction on the at least one target image region to obtain a first feature map of the at least one target image region; a down-sampling submodule, configured to perform N stages down-sampling on the first feature map to obtain an N-stage second feature map, where N is an integer greater than or equal to 1; an up-sampling submodule, configured to perform N stages up-sampling on an N-th stage second feature map to obtain an N-stage third feature map; and a classification submodule, configured to classify the N-th stage third feature map to obtain the first segmentation results of the target in the at least one target image region.

In some embodiments of the application, the up-sampling submodule includes: a connection submodule, configured to connect a third feature map obtained from an i-th stage up-sampling to an (N−i)-th stage second feature map, based on an attention mechanism in a case where i sequentially takes a value from 1 to N to obtain an i-th stage third feature map, where N is the number of stages of down-sampling and up-sampling, and i is an integer.

In some embodiments of the application, the to-be-processed image includes a 3D knee image, the second segmentation result includes a segmentation result of a knee cartilage, and the knee cartilage includes at least one of an FC, a TC or a PC.

In some embodiments of the application, the apparatus is implemented through a neutral network, and the apparatuses further include: a training module, configured to train the neutral network according to a preset training set, where the training set includes multiple sample images and annotation segmentation result of the sample images.

In some embodiments of the application, the neutral network includes a first segmentation network, at least one second segmentation network and a fusion segmentation network. The training module includes: a region determination submodule, configured to input a sample image into the first segmentation network, and output each sample image region of each target in the sample image; a second segmentation submodule, configured to input respectively each sample image region into the second segmentation network corresponding to each target, and output first segmentation results of the target in the each sample image regions; a third segmentation submodule, configured to input the first segmentation results of the target in the each sample image region and the sample images into the fusion segmentation network, and output the second segmentation result of the target in the sample image; a loss determination submodule, configured to determine a network loss of the first segmentation network, the second segmentation network and the fusion segmentation network according to the second segmentation results and the annotation segmentation results of the multiple sample images; and a parameter adjustment submodule, configured to adjust network parameters of the neutral network according to the network loss.

In some embodiments, the functions or included modules of the apparatus provided by the embodiment of the present disclosure are configured to execute the method described in the above method embodiments, and the specific implementation refers to the description in the above method embodiments. For the simplicity, the details are not elaborated herein.

The embodiments of the application further provide a computer-readable storage medium, having stored therein computer program instructions that, when being executed by a processor, cause to implement any of the image processing methods as described above. The computer-readable storage medium is a non-volatile computer-readable storage medium.

The embodiments of the application further provide an electronic device, which includes: a processor; and a memory, configured to store instructions executable by the processor; and the processor is configured to call the instruction stored in the memory to implement any of the image processing methods as described above.

The electronic device is provided as a terminal, a server or other types of devices.

The embodiments of the application further provide a computer program, which includes a computer-readable code; and when the computer-readable code runs in an electronic device, a processor in the electronic device executes any of the image processing methods as described above.

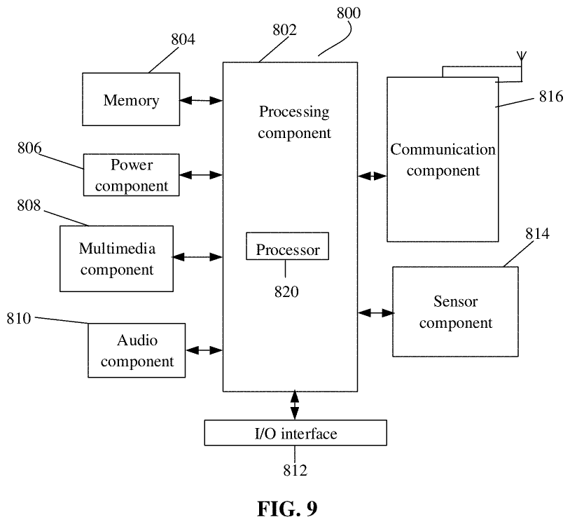

FIG. 9 is a structure diagram of an electronic device provided by an embodiment of the application. As shown in FIG. 9, the electronic device 800 is a terminal such as a mobile phone, a computer, a digital broadcast terminal, a messaging device, a gaming console, a tablet, a medical device, exercise equipment and a PDA.

Referring to FIG. 9, the electronic device 800 includes one or more of the following components: a processing component 802, a memory 804, a power component 806, a multimedia component 808, an audio component 810, Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 includes one or more processors 820 to execute instructions to perform all or part of the steps in the above described methods. Moreover, the processing component 802 includes one or more modules which facilitate the interaction between the processing component 802 and other components. For instance, the processing component 802 includes a multimedia module to facilitate the interaction between the multimedia component 808 and the processing component 802.

The memory 804 is configured to store various types of data to support the operation of the electronic device 800. Examples of such data include instructions for any application or method operated on the electronic device 800, contact data, phonebook data, messages, pictures, videos, etc. The memory 804 is implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power component 806 provides power to various components of the electronic device 800. The power component 806 includes a power management system, one or more power sources, and any other components associated with the generation, management, and distribution of power in the electronic device 800.

The multimedia component 808 includes a screen providing an output interface between the electronic device 800 and the user. In some embodiments, the screen includes a Liquid Crystal Display (LCD) and a Touch Panel (TP). If the screen includes the TP, the screen will be implemented as a touch screen to receive an input signal from the user. The TP includes one or more touch sensors to sense touches, swipes and gestures on the TP. The touch sensors not only sense a boundary of a touch or swipe action, but also sense a period of time and a pressure associated with the touch or swipe action. In some embodiments, the multimedia component 808 includes a front camera and/or a rear camera. The front camera and/or the rear camera receive external multimedia data when the electronic device 800 is in an operation mode, such as a photographing mode or a video mode. Each of the front camera and the rear camera is a fixed optical lens system or have focus and optical zoom capability.

The audio component 810 is configured to output and/or input audio signals. For example, the audio component 810 includes a Microphone (MIC) configured to receive an external audio signal when the electronic device 800 is in an operation mode, such as a call mode, a recording mode, and a voice recognition mode. The received audio signals are further stored in the memory 804 or transmitted via the communication component 816. In some embodiments, the audio component 810 further includes a speaker configured to output audio signals.

The first I/O interface 812 provides an interface between the processing component 802 and peripheral interface modules. The peripheral interface modules is a keyboard, a click wheel, buttons, or the like. The buttons include, but are not limited to, a home button, a volume button, a starting button, and a locking button.

The sensor component 814 includes one or more sensors to provide status assessments of various aspects of the electronic device 800. For instance, the sensor component 814 detects an on/off status of the electronic device 800 and relative positioning of components, such as a display and small keyboard of the electronic device 800, and the sensor component 814 further detects a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 includes a proximity sensor, configured to detect the presence of nearby targets without any physical contact. The sensor component 814 also includes a light sensor, such as a Complementary Metal Oxide Semiconductor (CMOS) or Charge Coupled Device (CCD) image sensor, configured for use in an imaging application. In some embodiments, the sensor component 814 also includes an accelerometer sensor, a gyroscope sensor, a magnetic sensor, a pressure sensor, or a temperature sensor.

The communication component 816 is configured to facilitate wired or wireless communication between the electronic device 800 and another device. The electronic device 800 accesses a communication-standard-based wireless network, such as a Wireless Fidelity (WiFi) network, a 2nd-Generation (2G) or 3rd-Generation (3G) network or a combination thereof. In one exemplary embodiment, the communication component 816 receives a broadcast signal or broadcast associated information from an external broadcast management system via a broadcast channel In one exemplary embodiment, the communication component 816 further includes a Near Field Communication (NFC) module to facilitate short-range communications. For example, the NFC module is implemented based on a Radio Frequency Identification (RFID) technology, an Infrared Data Association (IrDA) technology, an Ultra-Wideband (UWB) technology, a Bluetooth (BT) technology, and other technologies.

In the exemplary embodiment, the electronic device 800 is implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the above any image processing method.

In an exemplary embodiment, a non-volatile computer-readable storage medium, such as a first memory 804 including a computer program instruction, is further provided, the computer program instruction being executed by a processor 820 of the electronic device 800 to complete the above any image processing method.

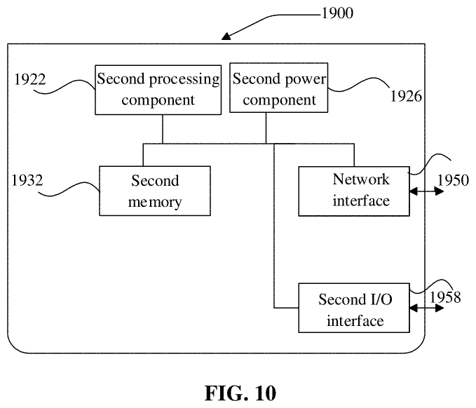

FIG. 10 is another structure diagram of an electronic device provided by an embodiment of the application. As shown in FIG. 10. The electronic device 1900 is provided as a server. Referring to FIG. 10, the electronic device 1900 includes a processing component 1922, further including one or more processors, and a memory resource represented by a memory 1932, configured to store an instruction executable for the processing component 1922, for example, an application program. The application program stored in the memory 1932 includes one or more modules, with each module corresponding to one group of instructions. In addition, the processing component 1922 is configured to execute the instruction to execute the abovementioned image processing method.

The electronic device 1900 further includes a power component 1926 configured to execute power management of the electronic device 1900, a wired or wireless network interface 1950 configured to connect the electronic device 1900 to a network and an I/O interface 1958. The electronic device 1900 is operated based on an operating system stored in the memory 1932, for example, Windows Server™, Mac OS XTM, Unix™, Linux™, FreeBSD™ or the like.

In an exemplary embodiment, a non-volatile computer-readable storage medium, for example, a memory 1932 including a computer program instruction, is also provided. The computer program instructions are executed by a processing component 1922 of an electronic device 1900 to implement the abovementioned method.

The embodiment of the application is a system, a method and/or a computer program product. The computer program product includes a computer-readable storage medium, in which a computer-readable program instruction configured to enable a processor to implement each aspect of the present disclosure is stored.

The computer-readable storage medium is a physical device capable of retaining and storing an instruction used by an instruction execution device. The computer-readable storage medium is, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instructions described here are downloaded from the computer-readable storage medium to each computing/processing device or downloaded to an external computer or an external storage device through a network such as an Internet, a Local Area Network (LAN), a Wide Area Network (WAN) and/or a wireless network. The network includes a copper transmission cable, an optical fiber transmission cable, a wireless transmission cable, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instructions configured to execute the operations of the application are an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instructions are completely or partially executed in a computer of a user, executed as an independent software package, executed partially in the computer of the user and partially in a remote computer, or executed completely in the remote server or a server. In a case involved in the remote computer, the remote computer is connected to the user computer via any type of network including the Local Area Network (LAN) or the Wide Area Network (WAN), or, is connected to an external computer (such as using an Internet service provider to provide the Internet connection). In some embodiments, an electronic circuit, such as a programmable logic circuit, a Field Programmable Gate Array (FPGA) or a Programmable Logic Array (PLA), is customized by using state information of the computer-readable program instruction. The electronic circuit executes the computer-readable program instruction to implement each aspect of the application.

Herein, each aspect of the embodiments of the application is described with reference to flowcharts and/or block diagrams of the method, device (system) and computer program product according to the embodiments of the application. It is to be understood that each block in the flowcharts and/or the block diagrams and a combination of each block in the flowcharts and/or the block diagrams will be implemented by computer-readable program instructions.

These computer-readable program instructions are provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions are also stored in a computer-readable storage medium, and through these instructions, the computer, the programmable data processing device and/or another device are work in a specific manner, so that the computer-readable medium including the instructions includes a product including instructions for implementing each aspect of the function/action specified in one or more blocks in the flowcharts and/or the block diagrams.

These computer-readable program instructions are further loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the application. On this aspect, each block in the flowcharts or the block diagrams represents part of a module, a program segment or an instruction, and part of the module, the program segment or the instruction includes one or more executable instructions configured to realize a specified logical function. In some alternative implementations, the functions marked in the blocks are also realized in a sequence different from those marked in the drawings. For example, two continuous blocks are actually executed in a substantially concurrent manner and are also executed in a reverse sequence sometimes, which is determined by the involved functions. It is further to be noted that each block in the block diagrams and/or the flowcharts and a combination of the blocks in the block diagrams and/or the flowcharts are implemented by a dedicated hardware-based system configured to execute a specified function or operation or are implemented by a combination of a special hardware and a computer instruction.

Each embodiment of the application has been described above. The above descriptions are exemplary, non-exhaustive and also not limited to each disclosed embodiment. Many modifications and variations are apparent to those of ordinary skill in the art without departing from the scope and spirit of each described embodiment of the present disclosure. The terms used herein are selected to explain the principle and practical application of each embodiment or technical improvements in the technologies in the market best or enable others of ordinary skill in the art to understand each embodiment disclosed herein.

### INDUSTRIAL APPLICABILITY

The application relates to the image processing method and apparatus, the electronic device and the storage medium. The method includes that: first segmentation is performed on a to-be-processed image to determine at least one target image region in the to-be-processed image; second segmentation is performed on the at least one target image region to determine a first segmentation result of a target in the at least one target image region; and fusion and segmentation are performed on the first segmentation result and the to-be-processed image to determine a second segmentation result of the target in the to-be-processed image. The embodiments of the application will improve the accuracy of segmentation on the target in the image.

1. An image processing method, comprising:
performing first segmentation on a to-be-processed image to determine at least one target image region in the to-be-processed image;
performing second segmentation on the at least one target image region to determine first segmentation results of a target in the at least one target image region; and
performing fusion and segmentation on the first segmentation results and the to-be-processed image to determine a second segmentation result of the target in the to-be-processed image.

2. The method of claim 1, wherein performing the fusion and the segmentation on the first segmentation results and the to-be-processed image to determine the second segmentation result of the target in the to-be-processed image comprises:
fusing each first segmentation result to obtain a fusion result; and
performing third segmentation on the fusion result according to the to-be-processed image to obtain the second segmentation result of the to-be-processed image.

3. The method of claim 1, wherein performing the first segmentation on the to-be-processed image to determine the at least one target image region in the to-be-processed image comprises:
performing feature extraction on the to-be-processed image to obtain a feature map of the to-be-processed image;
segmenting the feature map to determine a bounding box of the target in the feature map; and
determining the at least one target image region from the to-be-processed image according to the bounding box of the target in the feature map.

4. The method of claim 1, wherein performing the second segmentation on the at least one target image region to determine the first segmentation results of the target in the at least one target image region comprises:
performing feature extraction on the at least one target image region to obtain a first feature map of the at least one target image region;
performing N stages down-sampling on the first feature map to obtain an N-stage second feature map, wherein the N is an integer greater than or equal to 1;
performing N stages up-sampling on a N-th stage second feature map to obtain an N-th stage third feature map; and
classifying the N-th stage third feature map to obtain the first segmentation results of the target in the at least one target image region.

5. The method of claim 4, wherein performing the N stages up-sampling on the N-th stage second feature map to obtain the N-th stage third feature map comprises:
connecting a third feature map obtained from an i-th stage up-sampling to an (N−i)-th stage second feature map, based on an attention mechanism in a case where i sequentially takes a value from 1 to N, to obtain an i-th stage third feature map, wherein N denotes a number of stages of down-sampling and up-sampling, and i is an integer.

6. The method of claim 1, wherein the to-be-processed image comprises a Three-Dimensional (3D) knee image, the second segmentation result comprises a segmentation result of a knee cartilage, and the knee cartilage comprises at least one of a Femoral Cartilage (FC), a Tibial Cartilage (TC) or a Patellar Cartilage (PC).

7. The method of claim 1, wherein the method is implemented through a neutral network, and the method further comprises:
training the neutral network according to a preset training set, wherein the preset training set includes multiple sample images and annotation segmentation results of the sample images.

8. The method of claim 7, wherein the neutral network includes a first segmentation network, at least one second segmentation network and a fusion segmentation network; and
wherein training the neutral network according to the preset training set comprises:
inputting a sample image into the first segmentation network, and outputting each sample image region of each target in the sample image;
inputting, respectively, each sample image region into the second segmentation network corresponding to each target, and outputting first segmentation results of the target in each sample image region;
inputting the first segmentation results of the target in each sample image region and the sample image into the fusion segmentation network, and outputting the second segmentation result of the target in the sample image;
determining a network loss of the first segmentation network, the second segmentation network and the fusion segmentation network according to second segmentation results and annotation segmentation results of multiple sample images; and
adjusting network parameters of the neutral network according to the network loss.

9. An image processing apparatus, comprising:
a processor; and
a memory, configured to store instructions executable by the processor,
wherein the processor is configured to:
perform first segmentation on a to-be-processed image to determine at least one target image region in the to-be-processed image;
perform second segmentation on the at least one target image region to determine first segmentation results of a target in the at least one target image region; and
perform fusion and segmentation on the first segmentation results and the to-be-processed image to determine a second segmentation result of the target in the to-be-processed image.

10. The apparatus of claim 9, wherein the processor is specifically configured to:
fuse each first segmentation result to obtain a fusion result; and
perform third segmentation on the fusion result according to the to-be-processed image to obtain the second segmentation result of the to-be-processed image.

11. The apparatus of claim 9, wherein the processor is specifically configured to:
perform feature extraction on the to-be-processed image to obtain a feature map of the to-be-processed image;
segment the feature map to determine a bounding box of the target in the feature map; and
determine the at least one target image region from the to-be-processed image according to the bounding box of the target in the feature map.

12. The apparatus of claim 9, wherein the processor is specifically configured to:
perform feature extraction on the at least one target image region to obtain a first feature map of the at least one target image region;
perform N stages down-sampling on the first feature map to obtain an N-stage second feature map, wherein the N is an integer greater than or equal to 1;
perform N stages up-sampling on a N-th stage second feature map to obtain an N-th stage third feature map; and
classify the N-th stage third feature map to obtain the first segmentation results of the target in the at least one target image region.

13. The apparatus of claim 12, wherein the processor is specifically configured to:
connect a third feature map obtained from an i-th stage up-sampling to an (N−i)-th stage second feature map based on an attention mechanism in a case where i sequentially takes a value from 1 to N, to obtain an i-th stage third feature map, wherein N denotes a number of stages of down-sampling and up-sampling, and i is an integer.

14. The apparatus of claim 9, wherein the to-be-processed image comprises a Three-Dimensional (3D) knee image, the second segmentation result comprises a segmentation result of a knee cartilage, and the knee cartilage comprises at least one of a Femoral Cartilage (FC), a Tibial Cartilage (TC) or a Patellar Cartilage (PC).

15. The apparatus of claim 9, wherein the apparatus is implemented through a neutral network, and the processor is further configured to:
train the neutral network according to a preset training set, wherein the preset training set includes multiple sample images and annotation segmentation results of the sample images.

16. The apparatus of claim 15, wherein the neutral network includes a first segmentation network, at least one second segmentation network and a fusion segmentation network; and the processor is configured to:
input a sample image into the first segmentation network, and output each sample image region of each target in the sample image;
input respectively each sample image region into the second segmentation network corresponding to each target, and output first segmentation results of the target in each sample image region;
input the first segmentation results of the target in each sample image region and the sample image into the fusion segmentation network, and output the second segmentation result of the target in the sample image;
determine a network loss of the first segmentation network, the second segmentation network and the fusion segmentation network according to the second segmentation results and the annotation segmentation results of multiple sample images; and
adjust network parameters of the neutral network according to the network loss.

17. A non-transitory computer-readable storage medium, having stored therein a computer program instruction that, when being executed by a processor, causes to implement the following operations:
performing first segmentation on a to-be-processed image to determine at least one target image region in the to-be-processed image;
performing second segmentation on the at least one target image region to determine first segmentation results of a target in the at least one target image region; and
performing fusion and segmentation on the first segmentation results and the to-be-processed image to determine a second segmentation result of the target in the to-be-processed image.

18. The non-transitory computer-readable storage medium of claim 17, wherein the operation of performing the fusion and the segmentation on the first segmentation results and the to-be-processed image to determine the second segmentation result of the target in the to-be-processed image comprises:
fusing each first segmentation result to obtain a fusion result; and
performing third segmentation on the fusion result according to the to-be-processed image to obtain the second segmentation result of the to-be-processed image.

19. The non-transitory computer-readable storage medium of claim 17, wherein the operation of performing the first segmentation on the to-be-processed image to determine the at least one target image region in the to-be-processed image comprises:
performing feature extraction on the to-be-processed image to obtain a feature of the to-be-processed image;
segmenting the feature to determine a bounding box of the target in the feature; and
determining the at least one target image region from the to-be-processed image according to the bounding box of the target in the feature.

20. The non-transitory computer-readable storage medium of claim 17, wherein the operation of performing the second segmentation on the at least one target image region to determine the first segmentation results of the target in the at least one target image region comprises:
performing feature extraction on the at least one target image region to obtain a first feature of the at least one target image region;
performing N stages down-sampling on the first feature to obtain an N-stage second feature, wherein the N is an integer greater than or equal to 1;
performing N stages up-sampling on a N-th stage second feature map to obtain an N-th stage third feature map; and
classifying the N-th stage third feature map to obtain the first segmentation results of the target in the at least one target image region.
